(19) United States
(12) Patent Application Publication
(10) Pub. No.: US 2023/0305508 A1
(43) Pub. Date: Sep. 28, 2023

(54) SENSOR BOX, SYSTEM, AND METHOD

(71) Applicant: ACO AHLMANN SE & CO. KG, BÜDELSDORF (DE)

(72) Inventors: Thorsten CHRISTIAN, Hohenroda (US); Marco EULENSTEIN, Reichenbacherhof (US); Alexander LESER, (US); Sassan MAHMOODI, holzhausen a.d.H. (US)

(21) Appl. No.: 18/043,112

(22) PCT Filed: Sep. 17, 2021
(86) PCT No.: PCT/EP2021/075673

§ 371 Date: Feb. 27, 2023

(30) Foreign Application Priority Data
Sep. 23, 2020 (DE) 10 2020 124 749.4

(51) Int. Cl. G05B 19/042

(52) U.S. Cl. CPC G05B 19/0423; G05B 2219/21018

(57) ABSTRACT

The invention relates to a sensor box (10) for process-engineering and/or mechanical-engineering systems with a control unit and a plurality of interfaces (11) connected to the control unit, wherein the plurality of interfaces (11) can be connected or are connected to a corresponding number of cables or transmitting and receiving devices in order to establish a communicative connection to corresponding sensors (13) connected to different functional points of a process-engineering and/or mechanical-engineering system (12), and the control unit is configured to request corresponding measurements from the plurality of sensors (13) via the plurality of interfaces (11).

The invention relates to a sensor box for process-engineering and/or mechanical-engineering systems, in particular disposal systems and/or (wastewater) treatment systems such as grease separators, a system made up of a process-engineering and/or mechanical-engineering system and the sensor box, and a method for operating a process-engineering and/or mechanical-engineering system, in particular a facility having several such systems.

Process-engineering and mechanical-engineering systems are serviced at certain times for operational reasons. The corresponding working areas of the system are checked, maintained, and repaired according to a rotation. In the example of a wastewater system, the working areas can be an inlet, an outlet, a pump area, a sampling area, etc.

U.S. Pat. No. 8,943,911 B1 provides a system for remote monitoring of layers in grease separator systems with a detection unit for arrangement in a grease separator system and a wireless transmitter. The transmitter is electrically coupled to the detection unit to wirelessly transmit data recorded from the grease separator system regarding layers in the grease separator system; this data is received by a central server. After predetermined periods of time, data relating to the layers can be automatically wirelessly transmitted for analysis and display, for example on a website.

Remote monitoring of systems is thus known in the prior art. The invention is thus based on the object of improving maintenance and/or status detection, in particular real-time status detection, of such systems.

According to the invention, this object is achieved by a sensor box for a process-engineering and/or mechanical-engineering system with the feature of claim 1. With a view to the operation of a process-engineering and/or mechanical-engineering system, this object is achieved by the subject matter of claim 10.

Specifically, the object is achieved by a sensor box, for example in the form of a box, for a process-engineering and/or mechanical-engineering system, for example a disposal system and/or (wastewater) treatment system such as a grease separator. The sensor box has a control unit, for example in the form of a microcontroller. Furthermore, the sensor box has a plurality of interfaces. These interfaces can pass through a housing of the sensor box in order to provide a connection between the inside of the sensor box and the outside of the sensor box. The portion in the sensor box can be wired to the control unit. There is at least one connection between the control unit and the interfaces. The plurality of interfaces can be connected or is connected to a corresponding number of cables or transmitting and receiving devices. In this way, modularity can be provided with and without cabling. This can be replaced in the form of a retrofit kit. The transmitting and receiving devices can be designed optically or wirelessly, in particular wirelessly.

A communicative connection to corresponding sensors connected to different functional points of a process-engineering and/or mechanical-engineering system is provided or established via the cable. The system can be an industrial system, for example a disposal system and/or (wastewater) treatment system such as a grease separator and/or associated lifting system. The functional points can be provided at different locations in the system. In this case, different physical parameters or variables linked to the functional points are to be measured and, accordingly, different types of sensors are provided for different functional points. Furthermore, the functional points can be provided in groups according to the working areas of the system. Accordingly, the working areas can have several functional points that are provided with sensors in order to carry out measurements corresponding to the working area.

The cables can be explicitly dedicated cables for individual sensors, a subset, or all sensors. For example, the cables can have an identifier that is specifically visible to the human eye in order to avoid a wrong connection between the corresponding interface and the sensor. In this case, one interface of the plurality of interfaces can be provided or dedicated respectively for exactly one sensor or an interface of same. The control unit is configured to request or query corresponding measurements from the plurality of sensors via the plurality of interfaces. In this case, electricity can also be saved, since the sensor can be switched on or carry out a measurement simply by request/query. For this purpose, the sensor can have a separate power supply provided with the system. A power supply via the interfaces of the sensor box can therefore also be omitted.

In particular, the invention has the advantage that the sensor box can be constructed separately from the system and other systems in a modular manner. In particular, the sensor box can be attached or hung up in an operating space of a system. For this purpose, the sensor box can have appropriate holding devices in order to be hung on a wall.

Embodiments of the invention are specified in the dependent claims.

The sensor box can have or form an enclosure for the control unit. This enclosure can protect against conditions found in an operating space of the system and thus protect the control unit. The enclosure may be in the form of a hard cover. Various materials such as hard plastic can be provided. Furthermore, the sensor box can be portable, transportable, detachably fixed, or can be hung up in space. For this purpose, the sensor box can be replaced by in-house staff themselves.

The control unit may be configured to request measurements of various sensors of the plurality of sensors according to predetermined different frequencies of measurements per time. In this case, the measurements can be carried out in accordance with a sequence. This sequence can be different for each sensor or differ from functional point to functional point or from working area to working area. A query appropriate to the function of the system can thus be provided.

The sensor box can have a human-machine interface. The interface can also be provided by an instrument panel, for example a dashboard, which is in connection/communication with the sensor box via the control unit. In this case, the instrument panel can be provided via further instrumentation/an entity provided independently of the sensor box. The control unit can be configured to specify the different frequencies per time by input via the human-machine interface of the control unit on the outside of the sensor box. The frequencies per time of the measurements can differ from sensor to sensor of the plurality of sensors. The frequencies per time of the measurements can differ depending on certain working areas of the system. Sensors in a first working area can thus be queried more frequently than sensors in a second working area, which, in turn, can be queried more frequently than the sensors in a third working area.

The functional points can be linked to the working areas of the system. In particular, the working area can be a space in which a unit of the system provided for this space carries out its work. For example, a system may include a separator system, a lifting system, and a sampling pot connected between the separator system and the lifting system. In this case, there can be three working areas corresponding to the separator system, the lifting system, and the sampling pot. It is also possible for only the separator system and the lifting system to form respective working areas, in this example two working areas. The working areas can accordingly have several functional points. In particular, each working area can have several of the functional points. These functional points can be spatially spaced apart from one another. Thus, in general, a working area can be defined as a spatial area linked to the function of the corresponding unit of the system. The control unit may be configured to set the frequencies per time depending on the working area.

The above-mentioned object is also achieved in that a system is provided which is made up of a process-engineering and/or mechanical-engineering system and a sensor box assigned to the system, as described above for example. The system is configured to carry out a plurality of functions that are carried out spatially separately at the different functional points or spatially adjacent working areas of the system. The functional points are each equipped with or connected to one of the plurality of sensors. The plurality of sensors is configured to measure different physical parameters or variables assigned to a function of the corresponding functional point or the corresponding working areas upon request by the control unit.

The physical variable or the physical parameter results from the type of the respective sensor of the plurality of sensors. The plurality of sensors can at least partially comprise the following variants: an odor sensor, a temperature sensor (inlet), a level sensor, a pH sensor, a grease layer thickness meter, a temperature sensor (outlet), an acceleration sensor, a microphone, a volume flow meter, a pressure sensor, and a current transformer. The parameter to be measured or the variable to be measured is obvious to a person skilled in the art. The measurements are then transmitted from the sensor to the relevant interface of the sensor box in the form of data by means of signal transmission via the appropriate cable. This works, for example, only upon request/query by the control unit.

In this case, the control unit can serve as a switching unit and temporarily store the data/signals from the respective sensors. Memory unit(s), which are instructed by the control unit to store or temporarily store the data/signals from the respective sensors in certain areas, can be provided in the sensor box for temporary storage. In this case, not much memory is required due to the staggered request of the sensors by the control unit. For example, only one sensor can be queried per unit of time, so that serial storage is possible. However, parallel querying and storing is also possible.

The sensor box can have a communication unit with which communication can take place with an external entity, for example a higher-level and remote entity. The control unit can be provided for controlling the communication unit. For example, the control unit can instruct the communication unit to transmit the data/signals transmitted from the sensors to the external entity directly or from the memory units. The external entity is described below.

The system may include or be in communication with an Internet of things (IoT) platform. The IoT platform can be understood as the external entity. The control unit may be configured, after being requested, to transmit measurements obtained from the plurality of sensors (in the form of the data/signals mentioned above) to the IoT platform. The IoT platform can be intended to provide a database in order to record the measurements or data/signals transmitted by the control unit in the form of time series and, based on the time series, to provide an evaluation of the system and the functional points or working areas thereof. The IoT platform may be configured to determine a separate evaluation for each functional point and/or each working area based on the data received regarding the sensor measured values. Thus, several evaluations can be provided at the same time, for example one evaluation per functional point or working area. Advantageously, the IoT platform can combine the various data obtained from the various sensors, e.g. using an algorithm in the sense of artificial intelligence, and generate additional information on the system status, (waste)water quality, and/or maintenance status from the collected data and display it on the display instrument. The combinations of the sensors and the evaluation thereof in the system according to the invention allow greater operational reliability and a simplified method for measuring the wastewater quality to be achieved for the user in the area of predictive maintenance. The system may include an instrument panel (see above in relation to the dashboard). The instrument panel can be provided to query the evaluation from the IoT platform and to display the evaluation to a user. The evaluation can take the form of a warning message or an indication to the user of the instrument panel, for example in the form of a recommendation for action or a recommendation for setting the system. The instrument panel may be configured to display the evaluations to the user based on the level of urgency. Thus, a high degree of urgency can lead to the user being informed of the evaluation by repeated information in the form of warnings, even when the instrument panel is not being used directly, and a low degree of urgency can lead to the user being informed of the evaluation only when the instrument panel is being used directly.

The system can also contain a common gateway with other systems or technical systems or control units of same. The measurements transmitted by the control unit of the sensor box can be transmitted to the IoT platform in the form of data/signals (together with measurements transmitted by control units of other boxes) via the gateway. The gateway can transmit all measurements in the form of data/signals together or one after the other.

Thus, serial or parallel transmissions are possible. This can save either memory or time.

The gateway is a component that establishes a connection between the sensor box and the IoT platform and acts as an intermediary therebetween. The three entities of sensor box, gateway, and IoT platform can be positioned at different locations. Wireless communication can especially be set up between the sensor box and the gateway. In particular, the gateway is an Internet gateway. This gateway can be provided in a facility for several systems or the communication units/control units thereof. This means that all systems in a facility can communicate with the IoT platform via the gateway.

The above-mentioned object is also achieved in that a method is provided for operating a process-engineering and/or mechanical-engineering system. In this case, the method includes providing a sensor box, as described above, for example, in an operating space next to a system, as described above, for example. The sensor box can easily be attached to a wall of the operating space by hand. The method also includes connecting a plurality of sensors connected to the system to interfaces leading to a control unit of the sensor box. The sensors can be assigned to different working areas and attached to functional points linked to the working areas.

The method also includes a request by the control unit, via the interfaces, to the plurality of sensors for measurements from the plurality of sensors. Based on the request, the respective sensors can carry out measurements at at least partially different points in time and return these to the control unit by means of signals/data. It can also be provided here that the control unit actuates one or more of the corresponding sensors or supplies a signal at the start of the measurement. The measurement itself can be performed for a predetermined period of time. The length of time can be set with the request or included in the request.

Further, the method includes obtaining the measurements based on the requesting. The measurements are obtained from the relevant sensors via the above data/signals. The control unit can be provided with one or more memories for this purpose. The one or more memory units can also be contained in the sensor box itself. The method also includes transmitting the measurements to an external entity for evaluating the measurements. The personnel designated for the system can derive an action that is to be carried out from the evaluation.

It is obvious to a person skilled in the art that the explanations set forth herein may be implemented using hardware circuitry, software means, or a combination thereof. For example, the control unit can be partially implemented as a computer, a logic circuit, an FPGA (Field Programmable Gate Array), a processor (for example with a microprocessor, microcontroller, or vector processor), a core, and/or a CPU (Central Processing Unit).

In other examples, the control unit may be partially implemented as an FPU (Floating-Point Unit), an NPU (Numeric-Processing Unit), and/or an ALU (Arithmetic-Logic Unit). Furthermore, the control unit can be partially implemented as a co-processor (additional microprocessor to support a CPU), a GPGPU (General-Purpose Graphics Processing Unit), a parallel computer, and/or a DSP. For example, methods associated with pipelining can be used in the control unit. In this case, instead of an entire command, only a subtask is processed in one clock cycle of the processor. The various subtasks of several commands are processed simultaneously in this case. Furthermore, methods in the sense of multithreading and refinements thereof can be used in this case, for example simultaneous multithreading. This allows better utilization of the arithmetic units due to the parallel use of several processor cores.

The invention is explained in more detail in the following using exemplary embodiments with reference to the accompanying schematic figures.

In the figures:

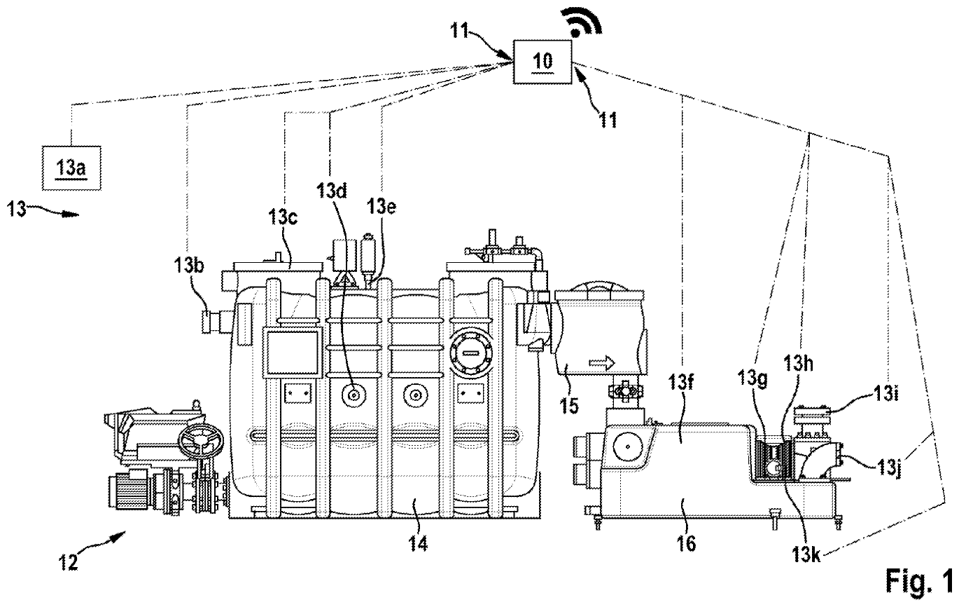

FIG. 1 is a view of a system with sensors and a sensor box; and

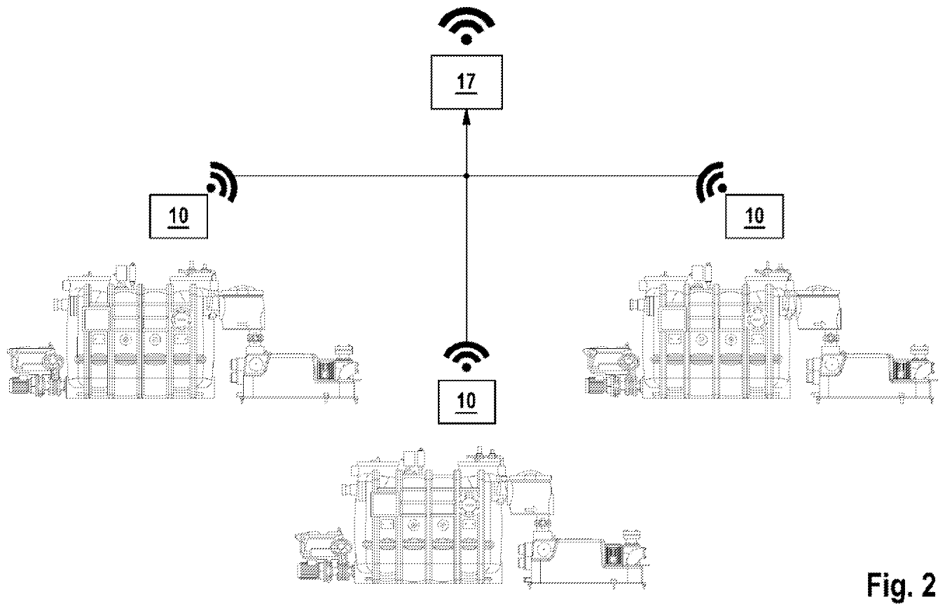

FIG. 2 is a view of several systems with a respective sensor box in combination with a gateway.

FIG. 1 shows a sensor box 10 which has several interfaces 11. Furthermore, a system 12 is shown which has several sensors 13 at different functional points on and in the vicinity of the system. The sensor box 10 is communicatively connected to the sensors 13. The sensors 13 are attached to different points of a system 12 shown in FIG. 1. Only one odor sensor 13a of the sensors 13 is arranged in the vicinity of the system 12. The system 12 has several functional points in three different working areas, which are specified, for example, by the separator 14, the sampling pot 15, or the lifting system 16.

The sensor box 10 is in the form of a box. In particular, the sensor box 10 is a box having a housing and containing a control unit (not shown) protected within the housing. Cables (shown in dashed lines) connect the several interfaces 11 of the sensor box 10 to the corresponding sensors 13. For example, exactly one dedicated cable can be used per interface. An electrical/communicative connection to the control unit (not shown) contained in the sensor box 10 is provided via the cables.

The control unit is a central control unit, like a microcontroller. The control unit requests sensor measurements separately for each sensor 13 at different time intervals for the sensors 13, given a previous configuration. This can be done by the control unit transmitting a signal for a respective sensor 13, which signal corresponds to a command to the sensor 13 to carry out a measurement. Based on this request, the respective sensor 13 returns a corresponding measurement, also referred to as a measured value, to the control unit. This measurement or measured values are then transmitted from the control unit in the sensor box 10 to a higher-level entity in a specific format, for example JSON format. This higher-level entity, for example an IoT platform (IoT cloud), is physically at a distance from the sensor box and only has a communicative connection to the sensor box 10. The transmission can take place directly into the IoT cloud via Message Queuing Telemetry Transport (MQTT) or Constrained Application Protocol (CoAP).

In particular, the sensors 13 mentioned below can be provided at different functional points of the system 12.

According to FIG. 1, the system 12 can be divided into three different working areas, each of which has the functional points. These three working areas can be divided into the area of the separator system 14, the sampling pot 15, and the lifting system 16. The following sensors 13 are arranged in the working area of the separator system 14: temperature sensor 13b of the inlet, level sensor 13c, pH sensor 13d, and grease layer thickness gauge 13e.

The temperature sensor 13b is provided to measure the temperature of the incoming water. The level sensor 13c is arranged in the tank of the separator system 14 in order to detect the level of grease in the container. The pH sensor 13d is also arranged in the tank of the separator system 14 in order to determine the pH value of the wastewater in the tank. The grease layer thickness gauge 13e is also arranged on the tank of the separator system 14 in order to transmit the grease layer thickness to the sensor box 10 or the control unit thereof.

In the present case, as shown in FIG. 1, the odor sensor 13a is arranged externally from the system 12 in order to detect unpleasant odors in the space in which the system 12 is located.

According to FIG. 1, no sensors are provided in the working area of the sampling pot 15.

In contrast to this, the working area of the lifting system 16 has several functional points which are provided with respective sensors 13f to 13k. The following sensors 13 are arranged in the working area of the lifting system 16: a temperature sensor 13f, an acceleration sensor 13g, a microphone 13h, a volume flow meter 13i, a pressure sensor 13j, and a current transformer 13k. The temperature sensor 13f is arranged in the water tank of the lifting system 16 in order to record the wastewater temperature. The acceleration sensor 13g is arranged on a pump of the lifting system 16 in order to record vibrations of the pump during operation. The microphone 13h is also arranged on the pump of the lifting system 16 in order to detect the volume and any deviations. The volumetric flow measuring device 13i is arranged in a pressure line of the lifting system 16 in order to record the volume delivered per unit of time. The pressure sensor 13j is arranged in a pressure line of the lifting system 16 in order to detect the outlet pressure of the pump. The current transformer 13k is arranged on the pump in order to non-invasively record the current consumption of a motor of the pump.

The control unit 10 transmits corresponding requests to the sensors 13 at predetermined times independently of the sensors 13 or the signaling thereof. Thus, all sensors 13 can be requested at the same time or at different times. The time intervals between requests can be variably adjusted. A needs-based request can be carried out in this case. In this way, different functional points can be occupied with different frequencies, and measurements can be requested as required. The measurements obtained from the sensors are transmitted to a cloud or IoT platform by means of data transmission. This transmission can take place via various data protocols or transmission schemes. For example, appropriate transmission means which can be used include Local Area Network (LAN), Wireless LAN (WLAN), Long Range Wide Area Network (LoRaWAN), Narrowband IoT (NB-IoT), Sigfox, or other transmission protocols.

In order to make the corresponding data related to the measurements usable, an instrument panel can be provided in the form of a dashboard. The data can be processed here and made available to the customer via web access or applications. Corresponding warnings, information, and statuses can also be transmitted (directly) by email, push message, or SMS. This can be done in the form of a warning system, for example the following outputs appear on the dashboard: overflow of the grease separator 14, excessive wastewater, excessive power consumption of the pumps of the lifting system 16, and/or insufficient pumping of wastewater.

Based on FIG. 2, which shows several systems 12, the boxes 10 provided for the various systems 12 or the control units (not shown) thereof can transmit the corresponding measurements of the sensors 13 from each system 12 to the higher-level IoT platform (not shown) via a gateway 17. It can be provided that the respective sensor box 10 transmits its data exclusively to the gateway 17, which forwards the data either individually, in parallel, or in series to the IoT platform or the cloud or transmits it collectively to the IoT platform or cloud. Fewer SIM cards are required in this case. The gateway 17 can be installed in a position that is convenient for all the boxes 10 of all the systems 12 in order to ensure optimum reception. Basically, one or more of the following transmission technologies can be used: NB-IoT, Global System for Mobile communications (GSM), and LoRa. In the case of transmission via the gateway 17, LoRa can be preferred. In particular, in the case of a single sensor box, but also in the case of several sensor boxes (i.e. in a network), the transmission can be encrypted during transmission via the gateway or without the gateway.

The IoT platform records the sensor data system-specifically in a time series database and evaluates it. The values can be assigned to individual systems and sensors assigned to the systems. Furthermore, the assignment can be tailored to and assigned to a specific customer.

In summary, the sensor box 10 from FIGS. 1 and 2 can provide a data acquisition unit which is connected to various sensors 13. The sensor box 10 can also be a retrofit kit for third-party systems in this case. In the case of grease separators 14 and lifting systems 16, data can be collected in real time and stored in an IoT platform. Data such as the temperature of liquids, pH value, filling level, etc. can be retrieved. The real-time collection of data is not limited to the system 12 of FIGS. 1 and 2, but can also be applied to other types of machinery. The data are also analyzed in order to derive services for customers, such as a warning system, condition monitoring, predictive maintenance, etc.

At this juncture, it should be noted that all the parts described above, viewed individually and in any combination, in particular the details shown in the drawings, are claimed to be essential to the invention. Modifications thereof are familiar to persons skilled in the art.

### LIST OF REFERENCE SIGNS

10 Sensor box
11 Interfaces
12 System
13 Plurality of sensors
13a Odor sensor
13b Temperature sensor (inlet)
13c Level sensor
13d pH-Sensor
13e Grease layer thickness gauge
13f Temperature sensor (outlet)
13g Acceleration sensor
13h Microphone
13i Volume flow meter
13j Pressure sensor
13k Current transformer
14 Separator system
15 Sampling pot
16 Lifting system
17 Gateway

1. A sensor box (10) for process-engineering and/or mechanical-engineering systems, wherein the sensor box has at least one control unit,
characterized in that
the sensor box (10) has a plurality of interfaces (11) connected to the control unit, which interfaces can be connected or are connected to a corresponding number of cables or transmitting and receiving devices in order to establish a communicative connection to corresponding sensors (13) connected to different functional points of a process-engineering and/or mechanical-engineering system (12), and the control unit is configured to request corresponding measurements of the plurality of sensors (13) via the plurality of interfaces (11).

2. The sensor box (10) according to claim 1,
characterized in that
the sensor box (10) forms an enclosure for the control unit and is portable, transportable, detachably fixed, or can be hung up in space.

3. The sensor box (10) according to claim 1,
characterized in that
the control unit is configured to request measurements from various sensors (13) of the plurality of sensors (13) according to predetermined different frequencies of measurements per time.

4. The sensor box (10) according to claim 1,
characterized in that
the control unit is configured to specify the different frequencies per time by input via a human-machine interface of the control unit externally on or in communication with the sensor box (10), wherein the frequencies per time of the measurements differ from sensor to sensor of the plurality of sensors (13).

5. The sensor box (10) according to claim 3,
characterized in that
the functional points are linked to one or more working areas (14, 15, 16) of the system (12), wherein each working area (14, 15, 16) has one or more of the functional points, and wherein the control unit is configured to specify the frequencies per time depending on the working area (14, 15, 16).

6. A system comprising a process-engineering and/or mechanical-engineering system (12) and a sensor box (10) assigned to the system (12) according to claim 1,
characterized in that
the system (12) is configured to perform one or more functions that are spatially separate and performed at least one of the different functional points or spatially adjacent to at least one working area (14, 15, 16) of the system (12), wherein the functional points are each equipped with or connected to at least one sensor (13) of the plurality of sensors, and wherein the at least one sensor (13) is configured to measure different physical parameters or variables assigned to a function of the corresponding functional point or the corresponding working area (14, 15, 16) upon request by the control unit.

7. The system according to claim 6,
characterized in that
the system contains or is in communication with an Internet of Things (IoT) platform in order to store and evaluate the measurements, and the control unit is configured, upon request, to transmit the measurements obtained from the at least one sensor (13) to the IoT platform, which is intended to provide a database in order to record the measurements transmitted by the control unit in the form of time series and, based on the time series, to submit an evaluation for the system (12) and the functional points or working areas thereof.

8. The system according to claim 7,
characterized in that
the system includes a display instrument/display which is provided to query the evaluation and/or the status associated therewith from the IoT platform and to display the evaluation and/or the status associated therewith to a user.

9. The system according to claim 7,
characterized in that
the system further contains, with other systems or technical systems or control units of same, one or more common gateways (17) via which the measurements are transmitted from the control unit of the sensor box (10) to the IoT platform.

10. A method for operating a process-engineering and/or mechanical-engineering system (12),
characterized by
the following steps:
providing a sensor box (10) according to claim 1 in an operating space next to and/or in connection with a process-engineering, mechanical-engineering, and/or wastewater-engineering system (12);
connecting at least one sensor (13) connected to the system (12) to interfaces (11) leading to a control unit of the sensor box (10);
requesting, by the control unit via the interfaces (11) to the at least one sensor (13), measurements of the at least one sensor (13);
obtaining the measurements based on the requesting; and
transmitting the measurements to an external entity for evaluation and assessment of the measurements.
